(19) United States
(12) Patent Application Publication
(10) Pub. No.: US 2004/0081428 A1
(43) Pub. Date: Apr. 29, 2004

(54) Reproducing apparatus and reproducing method of digital video information

(76) Inventors: Hideaki Funakoshi, Osaka (JP); Yoshihiro Yamanishi, Osaka (JP)

Correspondence Address: Jonathan P. Osha, ROSENTHAL & OSHA L.L.P., Suite 2800, 1221McKinney St., Houston, TX, 77010, US

(21) Appl. No.: 10/688,558

(22) Filed: Oct. 16, 2003

(30) Foreign Application Priority Data
Oct. 21, 2002 (JP) P2002-305342

(51) Int. Cl. H04N 5/783

(52) U.S. Cl. 386/68; 386/82

(57) ABSTRACT

When high speed reproduction of digital video information recorded on a DVD which is a record medium is performed at n-fold (n≧3) speed, by operating a high speed reproduction key of a remote control, an expansion unit is controlled by a control unit and a picture of one frame every several frames corresponding to n-fold speed reproduction is reproduced and subsequently normal reproduction of pictures of a required number of frames is sequentially performed.

### BACKGROUND OF THE INVENTION

1. Field of the Invention

The present invention relates to a reproducing apparatus and a reproducing method of digital video information, the apparatus and method for reproducing the digital video information based on MPEG standards recorded on optical disks such as CD-ROM or DVD, a DAT and other recording medium.

2. Description of the Related Art

According to a fast growth of multimedia, an image compression technique is suddenly in the limelight in order to simultaneously process a video signal and a audio signal and particularly, as international standards of compression and expansion of a color moving image, MPEG (Moving Picture Experts Group) has rapidly become widespread in application to a computer, communication, broadcast, entertainment and so on. Among them, MPEG1 (MPEG Phase 1) is used in storage medium such as CD-ROM or DAT, and MPEG2 (MPEG Phase 2) is used in digital broadcast or communication in addition to storage medium such as DVD.

A data array structure (bit stream) of MPEG forms a hierarchical structure as described in JP-A-8-051591 and in FIG. 3. As shown in FIG. 3, a sequence layer indicating the whole of one video program is constructed of several GOPs (Group Of Picture) 1 which are a video information block of a unit of a predetermined number of frames, and a GOP layer is constructed of several pictures (screen) 2, and a picture layer is constructed of slices 3 in which one picture 2 is divided into several blocks, and a slice layer is constructed of several macro blocks (hereinafter called MB) 4, and an MB layer is constructed of blocks 5 of 8 by 8 pixels (or scan lines).

Also, one block 5 of 8 by 8 pixels is the minimum unit of coding, namely DCT (Discrete Cosine Transform) in MPEG. On the other hand, the MB 4 is constructed of a total of six blocks 5 of four blocks 5 of a luminance signal Y and two blocks 5 of color signals CB, CR, and this MB 4 is the minimum unit of motion compensation prediction and a motion vector for the motion compensation prediction is performed in the MB unit.

Further, in the GOP 1, an Intra-coded Picture (hereinafter this is called an I picture) which is video information for performing intraframe coding, a Predictive-coded Picture (hereinafter this is called a P picture) which is video information for performing forward predictive coding and a Bidirectionally Predictive-coded Picture (hereinafter this is called a B picture) which is video information for performing bidirectionally predictive coding are mixed and as shown in FIG. 4, one GOP 1 is constructed of I, P and B pictures of a predetermined number of frames preset.

When each of the I, P and B pictures as shown in FIG. 4 is sequentially reproduced, normal reproduction by normal reproduction speed is achieved and when each of the pictures is reproduced by a reproduction multiple “n” (where n≧2) which is a multiple of reproduction speed to this normal speed, reproduction of high speed n times the normal speed is achieved. However, while the I picture can singly be reproduced since intraframe coding (DCT) is performed in the I picture, the P picture can be reproduced only after the I picture is reproduced since forward motion compensation is made in the P picture. Also, the B picture can be reproduced only after the I or P picture which is present forward or backward is reproduced since the B picture is a bidirectionally predictive screen.

However, in a case of a record medium such as DVD, the MPEG bit stream as shown in FIGS. 3 and 4 is recorded as it is, so that when special reproduction such as high speed reproduction attempts to be performed, reproduction can be performed only in a unit of the I picture and, that is, for a period of “A” in FIG. 5, reproduction of the I picture is performed and thereafter, only for a period of “C” in FIG. 5, frame advance is performed and these reproduction and frame advance are repeated. As a result of that, only a unit of video in each the GOP 1 could be reproduced and extreme frame skip reproduction was performed to result in a difficult-to-view reproduced image without continuity and it was very difficult to grasp a consequence of the image.

Incidentally, an apparatus for performing such high speed reproduction includes an apparatus described in a publication of JP-A-9-130796. However, the apparatus described in the publication has a technique for performing high speed reproduction of a color still image which is digital video information in which image compression processing compliant with JPEG (Joint Photographic coding Experts Group) which is a standard method for compressing and expanding a color still image is performed, and is an apparatus for attempting to smooth motion of an image of JPEG compressed data reproduced at high speed, and is not an apparatus for attempting to perform high speed reproduction of digital video information based on MPEG standards targeted for a color moving image.

### SUMMARY OF THE INVENTION

It is therefore an object of the invention is to provide a certain degree of continuity for video reproduced and make it easy to grasp consequence of the image in the case of performing high speed reproduction of digital video information recorded on a record medium.

In order to achieve the object, according to a first aspect of the invention, there is provided a reproducing apparatus for reproducing digital video information, the apparatus including: a readout unit configured to read out from a recording medium compressed video and audio data compliant with MPEG format having a structure of sequential video information blocks in a predetermined number of frames; a separation unit configured to separate the video data and the audio data from the compressed video and audio data read out by the readout unit; an expansion unit configured to respectively expand the video data and the audio data separated by the separation unit; a video output unit configured to output the video data expanded by the expansion unit; a audio output unit configured to output the audio data expanded by the expansion unit; an operation unit including a high speed reproduction key for reproducing the compressed video and audio data in n-fold (where n≧3) speed; and a control unit configured to control, in a case where the high speed reproduction key is operated, the expansion unit in order to perform reproduction of the compressed video and audio data by one frame every several frames corresponding to the n-fold speed and to perform reproduction of the compressed video and audio data in normal speed or in two-fold speed for a predetermined number of frames, alternately.

According to a second aspect of the invention, there is provided a reproducing method for reproducing digital video information, the method including: reading out from a recording medium compressed video and audio data compliant with MPEG format having a structure of sequential video information blocks in a predetermined number of frames; separating the video data and the audio data from the compressed video and audio data read out; respectively expanding the video data and the audio data separated; outputting the video data and the audio data expanded; controlling, in a case where a high speed reproduction for reproducing the compressed video and audio data in n-fold (where n≧3) speed is selected, the expanding in order to perform reproduction of the compressed video and audio data by one frame every several frames corresponding to the n-fold speed and to perform reproduction of the compressed video and audio data in normal speed or in two-fold speed for a predetermined number of frames, alternately.

### BRIEF DESCRIPTION OF THE DRAWINGS

The above objects and advantages of the present invention will become more apparent by describing preferred exemplary embodiments thereof in detail with reference to the accompanying drawings, wherein:

FIG. 1 is a block diagram of one embodiment according to the invention;

FIG. 2 is an action explanatory diagram of the embodiment;

FIG. 3 is an explanatory diagram showing data array structure of MPEG format;

FIG. 4 is an explanatory diagram showing a GOP of the MPEG format; and

FIG. 5 is an action explanatory diagram of a conventional example.

### DETAILED DESCRIPTION OF THE PREFERRED EMBODIMENTS

Referring now to the accompanying drawings, a description will be given in detail of preferred embodiments of the invention.

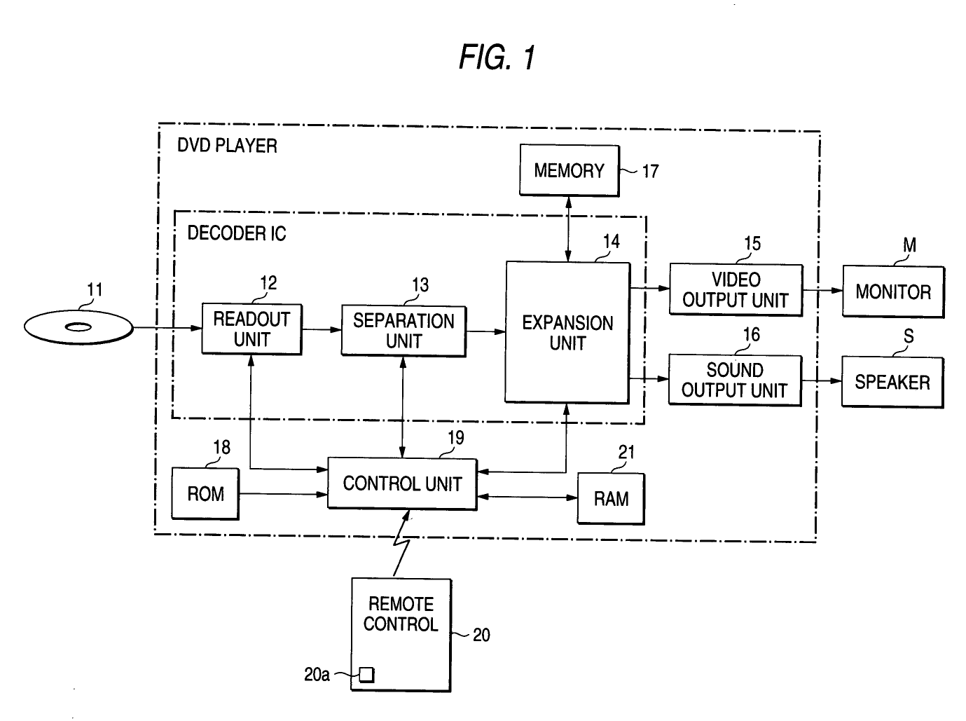

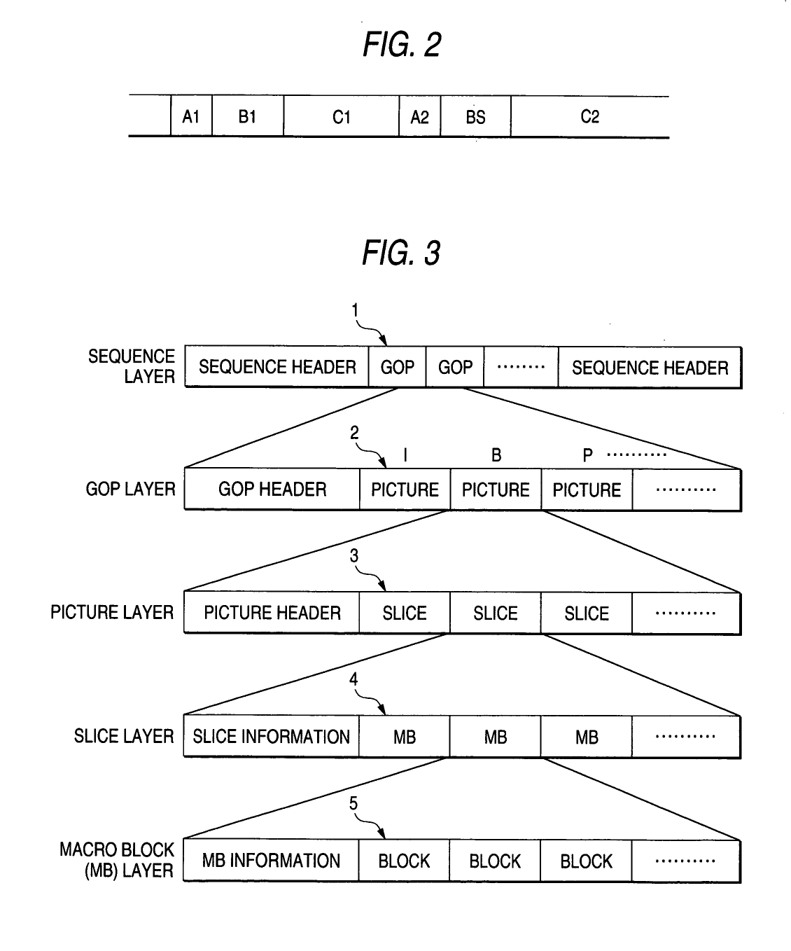

Hereinafter, a description will be given of an embodiment of a reproducing apparatus of a DVD (hereinafter this is called a DVD player) in which the invention is applied with reference to FIGS. 1 and 2.

In FIG. 1 showing a configuration of the DVD player, numeral 11 is a DVD acting as a recording medium rotated and driven by a driving system (not shown), and numeral 12 is a readout unit including an optical pickup, and numeral 13 is a separation unit for separating a compressed video data packet and a compressed audio data packet from compressed video and audio data read out by the readout unit 12, and numeral 14 is an expansion unit which respectively decodes the compressed video data packet and the compressed audio data packet separated by the separation unit 13 to expand the data packets into the original video and audio signal. Here, the readout unit 12, the separation unit 13 and the expansion unit 14 are constructed of a general decoder IC.

Further, in FIG. 1, numeral 15 is a video output unit for converting video data expanded by the expansion unit 14 into a color television signal of an NTSC or PAL format to produce an output in order to display the video data on a monitor screen M of, for example, a television, and numeral 16 is a audio output unit for outputting audio data expanded by the expansion unit 14 from a speaker S, and numeral 17 is memory comprising RAM for temporary storage of data expanded by the expansion unit 14, and numeral 18 is ROM for storing a control program by a control unit described below, and numeral 19 is a control unit which performs action control of the readout unit 12, the separation unit 13, the expansion unit 14 starting with the driving system of the DVD 11 in response to key operations of a remote control 20 which is an operation unit. Incidentally, numeral 21 is RAM for temporary storage of data, and the DVD player is constructed of the readout unit 12, the separation unit 13, the expansion unit 14, the video output unit 15, the audio output unit 16, the memory 17, the ROM 18, the control unit 19 and the RAM 21.

The remote control 20 is provided with a high speed reproduction key 20a for performing high speed reproduction at n-fold speed (the value “n” is a value such as 4, 8, 16, and the like) in addition to a reproduction key for reproduction at normal speed, namely performing normal reproduction or a stop key.

As a control program for reproduction stored in the ROM 18, control programs for reproduction of high speed such as two-fold speed, four-fold speed, eight-fold speed, ten-fold speed, sixteen-fold speed, twenty-fold speed or slow reproduction in addition to normal reproduction are associated with each control code and are stored in the ROM 18 and control of each the unit is performed by the control unit 19 according to each of these control programs and particularly at the time of reproduction, the expansion unit 14 performs decoding processing in response to the control code of the control program outputted from the control unit 19. Incidentally, as an example of the control code, control codes of “0000” for normal reproduction, “0001” for ten-fold speed reproduction, “0010” for two-fold speed reproduction, and the like are associated with each of the control programs.

In a case of normal reproduction, each the picture of each the GOP 1 described above is sequentially reproduced by the expansion unit 14 according to a control program of normal reproduction. In a case of two-fold speed reproduction, one picture every one frame of each the GOP 1 described above is reproduced by the expansion unit 14 basically according to a control program of two-fold speed reproduction and in the case of ten-fold speed reproduction, for example, one picture every ten frames of each the GOP 1 described above is reproduced by the expansion unit 14 basically according to a control program of ten-fold speed reproduction. However, even in a case of n-fold speed reproduction at this time, all of each the picture of each the GOP 1 are decoded and stored in the temporary memory 17 and only the necessary pictures are read out of the memory 17 and are outputted from the expansion unit 14 to the video output unit 15.

Incidentally, in the case of MPEG as described above, since reproduction is performed in an I picture unit, for example, when an I picture is absent in the ten frames ahead in ten-fold speed reproduction, an I picture present ahead of its picture is reproduced and one picture every ten frames is not reproduced exactly. That is, the ten-fold speed reproduction is not accomplished precisely in ten-fold speed but is accomplished in nearly ten-times shortened reproducing time.

When the high speed reproduction is set at ten-fold speed of normal speed and the high speed reproduction key 20a of the remote control 20 is operated, high speed reproduction of ten-fold speed by combination of a control program of normal reproduction of a control code of “0000” and a control program of ten-fold speed reproduction of a control code of “0001” stored in the ROM 18 is performed by the control unit 19.

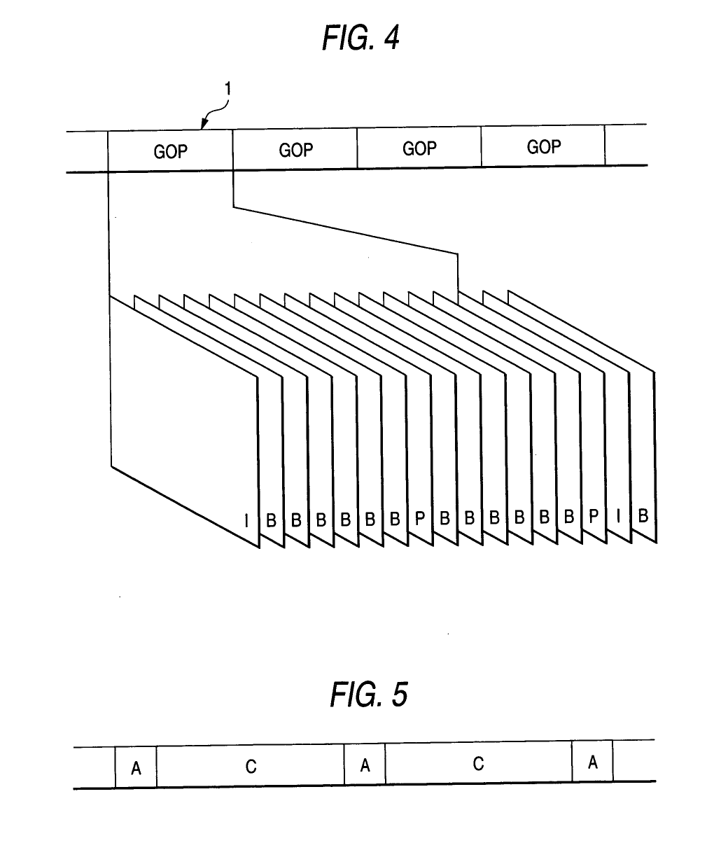

That is, the control code of “0001” is outputted from the control unit 19 to the expansion unit 14 and for a period of Al in FIG. 2, reproduction of video information by an I picture (see FIGS. 3 and 4) of one frame every several frames corresponding to ten-fold speed reproduction is performed by the expansion unit 14 and thereafter the control code of “0000” is outputted from the control unit 19 to the expansion unit 14 and for a period of B1 in FIG. 2, pictures of a required number of frames, for example, four frames continuous with the picture reproduced previously are normally reproduced and thereafter for only a certain time shown in a period of C1 in FIG. 2, a frame advance state continues.

Thereafter, the control code of “0001” is again outputted from the control unit 19 to the expansion unit 14 and for a period of A1 and A2 shown in FIG. 2, reproduction of video information by an I picture of one frame every several frames corresponding to ten-fold speed reproduction is performed by the expansion unit 14 and thereafter the control code of “0000” is outputted from the control unit 19 to the expansion unit 14 and for a period of B1 and B2 shown in FIG. 2, pictures of a required number of frames, for example, four frames continuous with the picture reproduced previously are normally reproduced and subsequently these actions are repeatedly performed.

As a result of the above control, even in the case of high speed reproduction of ten-fold speed, frame skip reproduction with a certain degree of continuity can be implemented. Incidentally, such high speed reproduction can also be applied at the time of fast-backward in addition to fast-forward.

Therefore, according to the embodiment described above, by operating the high speed reproduction key 20a of the remote control 20, the expansion unit 14 is controlled by the control unit 19 and video information is reproduced every “n” frames and subsequently video information about a required number of frames is sequentially reproduced, so that interlaced reproduction of video information every n frames and normal reproduction of video information about a required number of frames are continuously performed and thereby extreme frame skip reproduction as in conventional reproduction is not performed and frame skip reproduction with a certain degree of continuity can be implemented and even in the case of high speed reproduction such as ten-fold speed, consequence of the image can be grasped and retrieval of an image can be performed easily.

Incidentally, in the embodiment described above, the case of performing normal reproduction of video information about a required number of frames subsequent to interlaced reproduction by one frame every several frames corresponding to n-fold speed reproduction has been described, but as another embodiment, it may be configured so as to perform interlaced reproduction of compressed video and audio data of this one frame and subsequently perform two-fold speed reproduction of the compressed video and audio data of a required number of frames, and also in this case, an effect similar to that of the embodiment described above can be obtained.

In the embodiment described above, the case of performing high speed reproduction of ten-fold speed by combination of a control program of normal reproduction of a control code of “0000” and a control program of ten-fold speed reproduction of a control code of “0001” stored in the ROM 18 has been described, but as a further another embodiment, in the case of performing high speed reproduction in which compressed video and audio data of one frame every several frames corresponding to ten-fold speed reproduction is reproduced and subsequently normal reproduction (or two-fold speed reproduction) of the compressed video and audio data of a required number of frames is performed, it may naturally be programmed so as to perform such high speed reproduction by one control code.

Further, as a further another embodiment, it may be configured so that setting unit for variably setting a required number of frames of compressed video and audio data to perform normal reproduction or two-fold speed reproduction subsequent to reproduction of the compressed video and audio data of one frame at the time of high speed reproduction is provided and normal reproduction or two-fold speed reproduction of the compressed video and audio data of the number of frames set by operation of this setting unit is performed, and more specifically, it is preferably constructed so that a setting key acting as the setting unit is provided in the remote control 20 which is the operation unit and when a user sets a desired number of frames by operation of this setting key, normal reproduction or two-fold speed reproduction of the compressed video and audio data of this number of frames set is performed by the control unit 19.

In the case described above, time of normal reproduction or two-fold speed reproduction in B1 and B2 shown in FIG. 2 is variably set according to preferences of the user by operation of the setting unit and when it is difficult to grasp consequence of the image in the present setting, the number of frames may be increased to lengthen the time of normal reproduction or two-fold speed reproduction like B1, B2 and the consequence of the image can be grasped more clearly in frame skip reproduction with a certain degree of continuity.

As a further another embodiment, it may be configured so that normal reproduction or two-fold speed reproduction of video information about a required number of frames subsequent to interlaced reproduction by one frame every several frames corresponding to n-fold speed reproduction is alternatively performed and in this case, for example, it may be constructed so that a selection key acting as selection unit is provided in the remote control 20 which is the operation unit and when a user operates this selection key to select any of the normal reproduction or the two-fold speed reproduction, any of the normal reproduction or the two-fold speed reproduction selected is alternatively performed by the control unit 19.

Further, in the embodiment described above, the case of applying the invention to the DVD player which is the reproducing apparatus of digital video information has been described, but the invention is not limited to the DVD player, and the invention can naturally be applied to reproduction of other recording medium for storing compressed video and audio data compliant with MPEG and in any case, an advantage similar to that of the embodiment described above can be obtained.

Also, the invention is not limited to the embodiments described above, and various changes can be made other than the embodiments described above unless the changes deviate from the subject matter of the invention.

As described above, according to the invention, interlaced reproduction of compressed video and audio data by one frame every several frames corresponding to n-fold (n≦3) speed and normal reproduction or two-fold speed reproduction of the compressed video and audio data of a required number of frames are continuously performed, so that extreme frame skip reproduction as in conventional reproduction is not performed and frame skip reproduction with a certain degree of continuity is performed and high speed reproduction capable of grasping consequence of the image can be implemented and a reproducing apparatus (for example, a DVD player with an excellent function) of digital video information can be provided.

Also, according to the invention, time of normal reproduction or two-fold speed reproduction subsequent to reproduction of compressed video and audio data of one frame at the time of high speed reproduction can be variably set arbitrarily, so that consequence of the image can be grasped more clearly in frame skip reproduction with a certain degree of continuity.

Also, according to the invention, time of normal reproduction or two-fold speed reproduction subsequent to reproduction of compressed video and audio data of one frame at the time of high speed reproduction can be variably set simply by operation of a setting key of an operation unit.

Also, according to the invention, since a user operates selection unit and thereby can select which normal reproduction or two-fold speed reproduction subsequent to reproduction of compressed video and audio data of one frame at the time of high speed reproduction is performed according to preferences, adjustment can be made so that consequence of the image in frame skip reproduction is easily grasped more clearly.

Also, according to the invention, a selection as to which normal reproduction or two-fold speed reproduction subsequent to reproduction of compressed video and audio data of one frame at the time of high speed reproduction is performed can be made simply by operation of a selection key of an operation unit.

Also, according to the invention, when high speed reproduction of digital video information recorded on a record medium is performed at n-fold (n≧3) speed, interlaced reproduction of compressed video and audio data by one frame every several frames corresponding to the n-fold speed and normal reproduction or two-fold speed reproduction of the compressed video and audio data of a required number of frames are continuously performed, so that frame skip reproduction with a certain degree of continuity can be implemented and even in the case of high speed reproduction, consequence of the image can be grasped.

Also, according to the invention, time of normal reproduction or two-fold speed reproduction subsequent to reproduction of compressed video and audio data of one frame at the time of high speed reproduction can be variably set by variably setting a required number of frames, so that consequence of the image can be grasped more clearly in frame skip reproduction with a certain degree of continuity.

Also, according to the invention, since a selection as to which normal reproduction or two-fold speed reproduction subsequent to reproduction of compressed video and audio data of one frame at the time of high speed reproduction is performed can be made according to preferences, adjustment can be made so that consequence of the image in frame skip reproduction is easily grasped more clearly.

According to the invention, the image in frame skip reproduction is reproduced basically reproduced in normal speed (or in two-fold speed). Therefore, in comparison to a case where the image in frame skip reproduction is reproduced in n-fold speed (the speed faster than the two-fold speed), the invention can achieve a reproduction of the image more eye-friendly to the user.

Incidentally, in a conventional apparatus and method of frame skip reproduction, the image in frame skip reproduction is reproduced in N/M-fold speed, wherein the value N corresponds to N-fold speed search and the value M is a integer equals to or higher than 2. Therefore, the conventional apparatus and method needs a complicated software program that requires high processing power. However, in the present invention, the frame skip reproduction can be easily achieved by only switching the output of the control command such as “0000” and “0001”, and requires no special software program.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A reproducing apparatus for reproducing digital video information, the apparatus comprising:
a readout unit configured to read out from a recording medium compressed video and audio data compliant with MPEG format having a structure of sequential video information blocks in a predetermined number of frames;
a separation unit configured to separate the video data and the audio data from the compressed video and audio data read out by the readout unit;
an expansion unit configured to respectively expand the video data and the audio data separated by the separation unit;
a video output unit configured to output the video data expanded by the expansion unit;
a audio output unit configured to output the audio data expanded by the expansion unit;
an operation unit including a high speed reproduction key for reproducing the compressed video and audio data in n-fold (where n≧3) speed; and
a control unit configured to control, in a case where the high speed reproduction key is operated, the expansion unit in order to perform reproduction of the compressed video and audio data by one frame every several frames corresponding to the n-fold speed and to perform reproduction of the compressed video and audio data in normal speed or in two-fold speed for a predetermined number of frames, alternately.

2. The reproducing apparatus as claimed in claim 1 further comprising a setting unit configured to variably set the number of frames to perform the reproduction in the normal speed or in the two-fold speed in the high speed reproduction.

3. The reproducing apparatus as claimed in claim 2, wherein the setting unit comprises a setting key arranged in the operation unit.

4. The reproducing apparatus as claimed in claim 1 further comprising a selection unit configured to alternatively select to reproduce in normal speed or in two-fold speed for the predetermined number of frames in the high speed reproduction.

5. The reproducing apparatus as claimed in claim 4, wherein the selection unit comprises a setting key arranged in the operation unit.

6. A reproducing method for reproducing digital video information, the method comprising:
reading out from a recording medium compressed video and audio data compliant with MPEG format having a structure of sequential video information blocks in a predetermined number of frames;
separating the video data and the audio data from the compressed video and audio data read out;
respectively expanding the video data and the audio data separated;
outputting the video data and the audio data expanded;
controlling, in a case where a high speed reproduction for reproducing the compressed video and audio data in n-fold (where n≧3) speed is selected, the expanding in order to perform reproduction of the compressed video and audio data by one frame every several frames corresponding to the n-fold speed and to perform reproduction of the compressed video and audio data in normal speed or in two-fold speed for a predetermined number of frames, alternately.

7. The reproducing method as claimed in claim 6 further comprising variably setting the number of frames to perform the reproduction in the normal speed or in the two-fold speed in the high speed reproduction.

8. The reproducing method as claimed in claim 6 further comprising alternatively selecting to reproduce in normal speed or in two-fold speed for the predetermined number of frames in the high speed reproduction.
